(19) United States
(12) Patent Application Publication
(10) Pub. No.: US 2008/0099513 A1
(43) Pub. Date: May 1, 2008

(54) System For Dispensing A Fluid With A More Reliable Fitting Of The Plunger Tube

(76) Inventors: Jacques Beun, Criel Sur Mer (FR); Michel Plouffe, Westfield, MA (US); Pierre Dumont, Monchy-sur-EU (FR); Herve Lompech, Ansennes Bouttencourt (FR); Bernard Clerget, Haudevilliers (FR)

Correspondence Address: ST. ONGE STEWARD JOHNSTON & REENS, LLC, 986 BEDFORD STREET, STAMFORD, CT, 06905-5619, US

(21) Appl. No.: 11/876,270

(22) Filed: Oct. 22, 2007

(30) Foreign Application Priority Data
Oct. 23, 2006 (FR) 06 09284

(51) Int. Cl. B67D 5/60

(52) U.S. Cl. 222/464.1

(57) ABSTRACT

The invention relates to a system for dispensing a fluid contained in a flask, said system includes a body intended to be associated with said flask and a plunger tube mounted in an association portion formed on said body, wherein said tube is intended to be submerged in the fluid so as to enable said system to be supplied with fluid to be dispensed, with the association portion including a bore in which a portion of the plunger tube fits, and said bore has an annular projection with a diameter restricted with respect to the diameter of the portion of the tube that is fit, with said projection being formed at the junction between a lower converging portion and an upper diverging portion.

### CROSS-REFERENCE TO RELATED APPLICATIONS

The present application claims priority of French patent application No. 06 09284 filed on Oct. 23, 2006, the content of which is incorporated herein by reference.

### FIELD OF THE INVENTION

The invention relates to a system for dispensing fluid contained in a flask as well as a flask containing a fluid to be dispensed and on which such a dispensing system is mounted.

### BACKGROUND OF THE INVENTION

In a particular application, the dispensing system is intended to be provided in flasks used in perfumery, cosmetics or for pharmaceutical treatments. Indeed, this type of flask contains a liquid that must be restored by a dispensing system including a pump or a valve with manual actuation. In addition, these pumps or valves are themselves equipped with a plunger tube intended to be submerged in the liquid so as to enable said system to be supplied with liquid to be dispensed.

To do this, the pump or the valve conventionally includes a body provided with a lower bore into which the upper portion of the plunger tube fits. In particular, the plunger tube and the bore both have a cylindrical rotary shape, and the sealed connection is achieved by a radial tightening between these two shapes.

One of the problems with such a fitting is that of reliability, even though it enables proper dispensing of the fluid. In addition, the drop of the plunger tube during flask filling operations, or inside the packaged liquid, is not acceptable, in particular for the dispensing of a drug.

However, in particular due to the small diameter of the plunger tubes and the rates of assembly, which are high, it is not possible to exert the fitting force necessary for obtaining a strong tightening force. Moreover, due to its deformability, the reliability of the fitting of a plunger tube made of polymer material is also problematic, and this even more if the material is soft and/or ductile.

To solve this problem, document EP-0 701 951 proposes a bore provided with a peripheral ring for locally increasing the tightening force.

However, this solution is not satisfactory with regard to its production by moulding. Indeed, in forceful mould removal, the ring is capable of being torn or at least deformed, which alters its ability to improve the reliability of the fitting.

In addition, in order to increase the tightening force, the ring must even more project at the interior of the bore. This results in the formation of an obstacle on which, during the fitting, the end of the tube could butt or be deformed, which is contrary to the desired improvement.

Consequently, with this production, there is a significant risk of having a plunger tube that is poorly fit, poorly attached, that may come out of the bore, and this even more that the fitting speed is high on automatic assembly lines.

### SUMMARY OF THE INVENTION

The invention aims to solve the aforementioned problems by proposing in particular a dispensing system in which the plunger tube is mounted in a particularly reliable manner, while respecting the economic constraints related to the assembly rates and the production of the various elements that comprise it.

To this end, and according to a first aspect, the invention proposes a system for dispensing a fluid contained in a flask, which system includes a body intended to be associated with said flask and a plunger tube mounted in an association portion formed on said body, wherein said tube is intended to be submerged in the fluid so as to enable said system to be supplied with fluid to be dispensed, with the association portion including a bore in which a portion of the plunger tube fits, and said bore has an annular projection with a diameter restricted with respect to the diameter of the portion of the tube that is fit, with said projection being formed at the junction between a lower converging portion and an upper diverging portion.

According to a second aspect, the invention proposes a flask containing a fluid to be dispensed, said flask includes a body surmounted with a ring provided with an opening with which such a dispensing system is associated, the lower end of the plunger tube being submerged into the fluid so as to enable said system to be supplied with fluid to be dispensed.

### BRIEF DESCRIPTION OF THE DRAWINGS

Other objects and advantages of the invention will appear in the following description, in reference to the appended figures, in which:

FIG. 1 is a longitudinal cross-section view of the body of a dispensing system according to an embodiment of the invention;

FIG. 2 is a partial view of FIG. 1, showing the association portion of the plunger tube;

FIG. 3 is an analogous view to FIG. 2, the plunger tube being fit in the association portion.

### DETAILED DESCRIPTION OF THE INVENTION

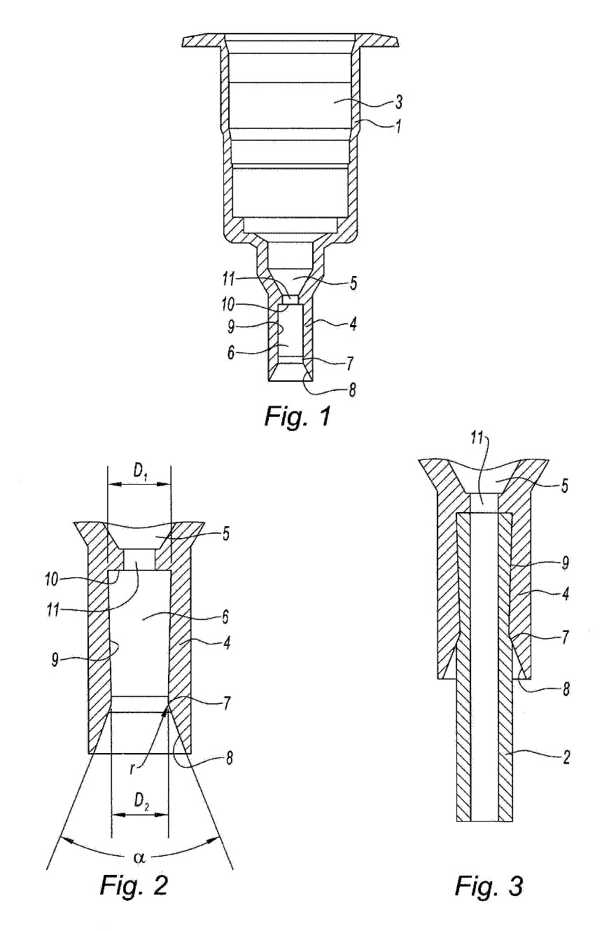

In the description, the terms for positioning in space have been used in reference to the position of the body as shown in FIG. 1.

The invention relates to a flask containing a fluid to be dispensed, in particular a perfume, a cosmetic product or a drug solution for a pharmaceutical treatment. The flask (not shown) conventionally includes a container, for example made of a polymer material or glass, which is surmounted by a ring provided with an opening with which a dispensing system is associated.

According to an embodiment, the flask contains an alcohol perfume solution, in particular such a solution that is colourless or slightly coloured. The flask includes a container that is transparent or at least translucent, for example made of glass or a colourless or slightly coloured plastic material. The container is intended to contain the solution while enabling the user to see it.

In particular, the dispensing system can include a pump or a valve with manual actuation, in particular by means of a push button. Thus, the system enables fluid to be dispensed, in particular by spraying.

Many types of pumps or valves are known, which can be used in the context of the invention, which is not limited to a particular production of these means.

In relation to the figures, an embodiment of a system for dispensing fluid contained in the flask is described, said system including a body 1, in particular based on a polymer material such as polypropylene, polyethylene, polyacetal (POM), polybutylene terephthalate (PBT) or a mixture of these materials.

The body 1 is arranged for the assembly of the dispensing system on the flask, in particular so as to be arranged in a sealed manner in the opening of said flask. In addition, the dispensing system includes a plunger tube 2 of which the lower end is submerged in the liquid in order to enable said system to be supplied with fluid to be dispensed.

The body 1 shown has a rotary shape and includes, in the upper portion 3, recesses for the functional components of the pump or the valve. In addition, an association portion 4 of the plunger tube 2 is formed in the lower portion of said body. In the figure, the association portion 4 is surmounted by a portion 5 that forms a seat for a valve, in particular formed by a ball, so as to be capable of supplying the upper portion of the body 1 with the fluid from the plunger tube 2.

The association portion 4 includes a bore 6 in which the upper portion of the plunger tube 2 fits (FIG. 3) so as to mount said plunger tube in said association portion. In the embodiment shown, the bore 6 has a profile with a cylindrical rotary cross-section and the plunger tube 2 has a cylindrical rotary shape. Thus, the plunger tube 2 can be made conventionally by extrusion of a polymer material, in particular based on polypropylene, polyethylene, polymethylpentene (TPX) or a mixture of these materials.

According to an embodiment, the plunger tube 2 is made of a material based on fluorinated polymer, for example based on polytetrafluoroethylene (PTFE), and in particular based on PTFE block copolymer. In particular examples, the material of which the plunger tube 2 is made is a PTFE block copolymer—perfluoromethylvinylether (MFA) or a PTFE block copolymer—ethylene—hexafluoropropylene—fluoroterpolymer (EFEP) block copolymer. In another embodiment example, the material is an amorphous PTFE in Teflon AF-type.

These plunger tubes 2 have the advantage of being invisible when submerged in an alcohol perfume solution. However, they present problems of fitting, and in particular reliability and high-speed production of it, in particular due to the anti-adhesion properties of this material and its low creep resistance. Thus, the fitting of a cylindrical plunger tube made of fluorinated polymer in a cylindrical bore is not entirely satisfactory, even if the thickness of the tube is slightly increased.

To increase the tightening force, the bore 6 has an internal annular projection 7 of which the diameter is restricted with respect to the diameter of the portion of the tube 2 that is fit. In addition, the projection 7 is formed at the junction between a lower converging portion 8 and an upper diverging portion 9, so as to facilitate the insertion of the plunger tube 2 into the bore 6 and to limit the fitting force needed.

In the figures, the lower converging portion 8 has an inlet diameter that is greater than the portion of the tube 2 that is fit, so as to form a chamfer facilitating the passage of the tube 2 into the bore 6.

In addition, the upper diverging portion 9 has an outlet diameter D1 that is at least equal, in particular substantially equal, to that before fitting of the portion of the tube 2 that is fit. Thus, the upper end of the fit portion is not substantially constrained at the level of this outlet diameter D1, so that the material retains its full elasticity in order to resist the peel stresses of the plunger tube 2 outside of the bore 6.

Furthermore, the upper diverging portion 9 is limited by an axial dead stop 10 of the fitting of the plunger tube 2, said stop is open at its centre to form a channel 11 for passage of fluid from the plunger tube 2 to the inside of the body 1.

In particular embodiment examples, the dispensing system can have, alone or in combination, the following features:
a diameter D2 of the projection between 85% and 95% of the diameter of the plunger tube 2 before fitting;
a conical lower converging portion 8 with an opening angle α that is smaller than or equal to 20°, in particular on the order of 20°;
a projection 7 with a blend radius r between the converging portion 8 and the diverging portion 9, which is at least equal to 1 mm;
a length of the upper diverging area 9 that is on the order of twice the diameter of the plunger tube 2.

These various features make it possible to facilitate the insertion of the plunger tube 2 into the bore 6 and to make the fitting of the plunger tube 2 in the association portion 4 more reliable. The shape of the bore 6 also makes it possible to apply a fitting force on the plunger tube 2 that is low and therefore compatible with ductile materials. In addition, in the fitting, the risks of deformation of the end of the plunger tube 2, in particular on the projection 7, are limited.

Furthermore, the association portion 4 can easily be produced by moulding. Indeed, the bore 6 has a gentle and gradual shape, which enables easy mould removal from the counter taper.

By way of example, for a polypropylene body 1 and a plunger tube 2 made of a fluorinated polymer (EFEP) with a front fitting diameter equal to 1.51 mm, the diameter D2 of the projection is 1.35 mm, the outlet diameter D1 is equal to 1.53 mm and the angle α is 20°. The peel force of this plunger tube 2 after aging and stabilisation is at least equal to 2 daN.

1. System for dispensing a fluid contained in a flask, said system includes a body intended to be associated with said flask and a plunger tube mounted in an association portion formed on said body, wherein said tube is intended to be submerged in the fluid so as to enable said system to be supplied with fluid to be dispensed, the association portion including a bore in which a portion of the plunger tube fits, and said bore has an annular projection with a diameter restricted with respect to the diameter of the portion of the tube that is fit, said projection being formed at the junction between a lower converging portion and an upper diverging portion.

2. Dispensing system according to claim 1, characterised in that the bore has a profile with a cylindrical rotary cross-section and the plunger tube has a cylindrical rotary shape.

3. Dispensing system according to claim 2, characterised in that the converging portion has an inlet diameter that is greater than that before fitting of the tube portion that is fit.

4. Dispensing system according to claim 2, characterised in that the diverging portion has an outlet diameter that is at least equal to that of the tube portion that is fit.

5. Dispensing system according to claim 2 4, characterised in that the diameter of the projection is between 85% and 95% of the diameter of the plunger tube before fitting.

6. Dispensing system according to claim 1, characterised in that the upper diverging portion is limited by an axial dead stop of the fitting of the plunger tube.

7. Dispensing system according to claim 1, characterised in that the lower converging portion is conical with an opening angle that is smaller than or equal to 20°.

8. Dispensing system according to claim 1, characterised in that the projection has a blend radius between the converging portion and the diverging portion that is at least equal to 1 mm.

9. Dispensing system according to claim 2, characterised in that the length of the upper diverging area is on the order of twice the diameter of the plunger tube.

10. Dispensing system according to claim 1, characterised in that the plunger tube is based on a fluorinated polymer.

11. Flask containing a fluid to be dispensed, said flask includes a body surmounted with a ring provided with an opening with which a dispensing system according to claim 1 is associated, the lower end of the plunger tube being submerged into the fluid so as to enable said system to be supplied with fluid to be dispensed.

12. Dispensing system according to claim 3, characterised in that the diverging portion has an outlet diameter that is at least equal to that of the tube portion that is fit.
